(19) United States
(12) Patent Application Publication
(10) Pub. No.: US 2024/0388367 A1
(43) Pub. Date: Nov. 21, 2024

(54) SIGNAL PROCESSING APPARATUS

(71) Applicant: HUAWEI TECHNOLOGIES CO., LTD., Shenzhen (CN)

(72) Inventors: Dong LIANG, Shenzhen (CN); Jianan ZHANG, Shenzhen (CN); Junping ZHANG, Shenzhen (CN)

(21) Appl. No.: 18/786,953

(22) Filed: Jul. 29, 2024

Related U.S. Application Data
(63) Continuation of application No. PCT/CN2022/141777, filed on Dec. 26, 2022.

(30) Foreign Application Priority Data
Jan. 30, 2022 (CN) 202210114343.5

(51) Int. Cl. H04B 10/69

(52) U.S. Cl. CPC H04B 10/691

(57) ABSTRACT

The technology of this application relates to a signal processing apparatus having functions of communication and positioning and sensing, so that complexity of a photoelectric detector array is reduced. The apparatus includes N photoelectric detector unit subarrays and M output ports respectively connected to the N photoelectric detector unit subarrays, where at least two of the N photoelectric detector unit subarrays are different, a quantity of photoelectric detector units included in at least one of the N photoelectric detector unit subarrays is greater than or equal to 2, N is an integer greater than or equal to 2, and M is an integer less than or equal to N. A photoelectric detector unit in the N photoelectric detector unit subarrays is configured to perform photoelectric conversion on an optical signal, to obtain a first electrical signal, and the M output ports are configured to output the first electrical signal.

### CROSS-REFERENCE TO RELATED APPLICATIONS

This application is a continuation of International Application No. PCT/CN2022/141777, filed on Dec. 26, 2022, which claims priority to Chinese Patent Application No. 202210114343.5, filed on Jan. 30, 2022. The disclosures of the aforementioned applications are hereby incorporated by reference in their entireties.

### TECHNICAL FIELD

This disclosure relates to the field of wireless technologies, and in particular, to a signal processing apparatus.

### BACKGROUND

An optical wireless communication technology is one of key fields in wireless communication technologies. The optical wireless communication technology has advantages such as large available bandwidth, a small transmit antenna, and anti-electromagnetic interference. The industry and academia have corresponding system solutions for scenarios such as indoor short-distance and outdoor long-distance communication, and actively carry out system-level test and demonstration and key technology exploration.

Currently, in an implementation process of optical wireless communication, photoelectric conversion is usually performed on an optical signal by using a photoelectric detector array in a signal receiver, to obtain an electrical signal, so as to implement communication. With development of technologies, high-precision positioning and sensing performed by using an optical signal (such as visible light or near-infrared light) is also a typical application scenario. That is, in addition to carrying communication data, an optical signal received by the signal receiver may further carry positioning data or sensing data. The photoelectric detector array includes a plurality of photoelectric detectors and electrical signal output ports that are in one-to-one correspondence with the plurality of photoelectric detectors, so that the signal receiver obtains an electrical signal obtained by each photoelectric detector.

However, in the foregoing implementation, because a corresponding electrical signal output port needs to be disposed for each photoelectric detector, complexity of the photoelectric detector array is high.

### SUMMARY

A first aspect of this disclosure provides a signal processing apparatus, applied to the optical signal processing field. The signal processing apparatus may perform photoelectric conversion on an optical signal, to obtain an electrical signal. The optical signal may be used to carry a plurality of types of data, for example, communication data and positioning data. Specifically, the apparatus includes N photoelectric detector unit subarrays and M output ports respectively connected to the N photoelectric detector unit subarrays, where at least two of the N photoelectric detector unit subarrays are different, a quantity of photoelectric detector units included in at least one of the N photoelectric detector unit subarrays is greater than or equal to 2, N is an integer greater than or equal to 2, and M is an integer less than or equal to N; a photoelectric detector unit in the N photoelectric detector unit subarrays is configured to perform photoelectric conversion on an optical signal, to obtain a first electrical signal; and the M output ports are configured to output the first electrical signal.

Based on the foregoing technical solution, in the signal processing apparatus, a quantity of photoelectric detector unit subarrays is N, a quantity of output interfaces connected to the N photoelectric detector unit subarrays is M, and M is an integer less than or equal to N. That is, the quantity of output interfaces is less than or equal to the quantity of photoelectric detector unit subarrays. In addition, the quantity of photoelectric detector units included in the at least one of the N photoelectric detector unit subarrays is greater than or equal to 2. In other words, the quantity of output interfaces is less than a quantity of photoelectric detectors. Therefore, there is no need to dispose a corresponding electrical signal output port for each photoelectric detector, so that complexity of a photoelectric detector array is reduced.

In addition, because the at least two of the N photoelectric detector unit subarrays are different, an arrangement of photoelectric detector units in different photoelectric detector unit subarrays is more flexible.

It should be noted that the photoelectric detector in this disclosure may include one or more of a photodiode (PD), a PIN photodiode (PIN-PD), and an avalanche photodiode (APD).

It should be understood that M is an integer less than or equal to N. When M is an integer equal to N, the N photoelectric detector unit subarrays are in a one-to-one correspondence with the M output ports. When M is an integer less than N, the at least two of the N photoelectric detector unit subarrays correspond to a same output port in the M output ports.

In a possible implementation of the first aspect, that at least two of the N photoelectric detector unit subarrays are different includes at least one of the following:
shapes of the at least two of the N photoelectric detector unit subarrays are different;
areas of the at least two of the N photoelectric detector unit subarrays are different;
quantities of photoelectric detector units included in the at least two of the N photoelectric detector unit subarrays are different;
areas of photosensitive surfaces of photoelectric detectors included in the at least two of the N photoelectric detector unit subarrays are different; or
spacings (or sparseness degrees) between photoelectric detector units included in the at least two of the N photoelectric detector unit subarrays are different.

Based on the foregoing technical solution, in the N photoelectric detector unit subarrays in the signal processing apparatus, at least one of the shapes, the areas, the quantities of included photoelectric detector units, the areas of photosensitive surfaces of included photoelectric detectors, and the spacings between the included photoelectric detector units of the at least two photoelectric detector unit subarrays are different. During actual application, because the optical signal may not be evenly irradiated in the N photoelectric detector unit subarrays, the photoelectric detector unit subarrays may be flexibly configured based on an application scenario.

It should be understood that “irradiation” in this disclosure may also be replaced with focusing, projection, coverage, or the like.

In a possible implementation of the first aspect, photosensitive surfaces of an array formed by the N photoelectric detector unit subarrays are axisymmetrically distributed.

Based on the foregoing technical solution, the photosensitive surfaces of the array formed by the N photoelectric detector unit subarrays are axisymmetrically distributed, so that a processing capability corresponding to an optical signal received by the signal processing apparatus at a specific angle on one side of an axis is the same or similar to a processing capability corresponding to an optical signal received by the signal processing apparatus at the specific angle on the other side of the axis.

In a possible implementation of the first aspect, the photoelectric detector unit includes a photoelectric detector.

In a possible implementation of the first aspect, the photoelectric detector unit includes a switch and a photoelectric detector.

Based on the foregoing technical solution, the photoelectric detector unit includes the switch and the photoelectric detector, so that a working mode of the photoelectric detector may be configured by using the switch. Therefore, based on control of a scheduling policy of photoelectric detectors included in the N photoelectric detector unit subarrays, application of high-precision angle-of-arrival (AOA) estimation and/or positioning can be implemented.

Optionally, the switch is configured to control connection or disconnection of the photoelectric detector.

In a possible implementation of the first aspect, the photoelectric detector unit further includes an inductor and an impedance circuit.

Based on the foregoing technical solution, in addition to the switch and the photoelectric detector, the photoelectric detector unit may further include the inductor and the impedance circuit, so that a circuit unit is formed when the inductor is connected to the photoelectric detector. Output impedance of the circuit unit is related to the inductor and the photoelectric detector, and has small reflection, to ensure that input/output impedance of the photoelectric detector unit is close to default input/output impedance. Similarly, a circuit unit is formed when the inductor is connected to the impedance circuit. Output impedance of the circuit unit is related to the inductor and the impedance circuit, and can also have small reflection, to ensure that the input/output impedance of the photoelectric detector unit is close to the default input/output impedance.

Optionally, the default input/output impedance may be 50 ohms or another value. This is not limited herein.

Optionally, the switch is configured to control the photoelectric detector to be connected to the inductor, and control the impedance circuit to be disconnected from the inductor; or the switch is configured to control the photoelectric detector to be disconnected from the inductor, and control the impedance circuit to be connected to the inductor.

Further, optionally, the apparatus further includes a controller. The controller is configured to control, by using the switch, the photoelectric detector to be connected to the inductor, and control the impedance circuit to be disconnected from the inductor; or the controller is configured to control, by using the switch, the photoelectric detector to be disconnected from the inductor, and control the impedance circuit to be connected to the inductor.

In a possible implementation of the first aspect, a difference between impedance of the photoelectric detector and impedance of the impedance circuit is less than a threshold.

Based on the foregoing technical solution, the difference between the impedance of the photoelectric detector and the impedance of the impedance circuit is less than the threshold. That is, the impedance of the photoelectric detector is the same as or close to the impedance of the impedance circuit. In this way, input/output impedance generated by the photoelectric detector unit when the inductor is connected to the photoelectric detector is the same or close to input/output impedance generated by the photoelectric detector unit when the inductor is connected to the impedance circuit, so that in a switch switching process, it is ensured that the photoelectric detector unit subarrays have a constant or similar electrical characteristic.

Optionally, the difference is 0.

In a possible implementation of the first aspect, the N photoelectric detector unit subarrays are located on a same plane.

In a possible implementation of the first aspect, the N photoelectric detector unit subarrays include K photoelectric detector unit subarrays and P photoelectric detector unit subarrays, both K and P are integers greater than or equal to 1, and a sum of K and P is less than or equal to N; and a plane formed by projections, on a first plane, of photosensitive surfaces formed by photoelectric detectors in the K photoelectric detector unit subarrays and projections, on the first plane, of photosensitive surfaces formed by photoelectric detectors in the P photoelectric detector unit subarrays is continuous.

Based on the foregoing technical solution, the N photoelectric detector unit subarrays include at least the K photoelectric detector unit subarrays and the P photoelectric detector unit subarrays. The plane formed by the projections, on the first plane, of the photosensitive surfaces formed by the photoelectric detectors in the K photoelectric detector unit subarrays and the projections, on the first plane, of the photosensitive surfaces formed by the photoelectric detectors in the P photoelectric detector unit subarrays is continuous. In other words, the photosensitive surfaces formed by the photoelectric detectors in the K photoelectric detector unit subarrays and the photosensitive surfaces formed by the photoelectric detectors in the P photoelectric detector unit subarrays are complementary to each other. Therefore, different photoelectric detector unit subarrays jointly receive the optical signal, and photosensitive surfaces corresponding to different photoelectric detector unit subarrays are complementary to each other, to reduce blind spots between different photosensitive surfaces formed by different photoelectric detector unit subarrays.

It should be understood that the first plane is any plane.

In a possible implementation of the first aspect, photoelectric detector units in the K photoelectric detector unit subarrays are located on a second plane, photoelectric detector units in the P photoelectric detector unit subarrays are located on a third plane, and the second plane is not coplanar with the third plane.

Optionally, an included angle between the second plane and the third plane is 90° to 150°.

Optionally, an included angle between the second plane and the third plane is 90°.

In a possible implementation of the first aspect, the N photoelectric detector unit subarrays further include Q photoelectric detector unit subarrays, where Q is an integer greater than or equal to 1, and a sum of K, P, and Q is less than or equal to N; and the Q photoelectric detector unit subarrays are located on a plurality of planes, the plurality of planes are not coplanar with the second plane, and the plurality of planes are not coplanar with the third plane.

Based on the foregoing technical solution, in addition to the K photoelectric detector unit subarrays and the P photoelectric detector unit subarrays, the N photoelectric detector unit subarrays may further include the Q photoelectric detector unit subarrays, where the Q photoelectric detector unit subarrays are located on the plurality of planes, the plurality of planes are not coplanar with the second plane, and the plurality of planes are not coplanar with the third plane. In this way, the plurality of planes on which the Q photoelectric detector unit subarrays are located can improve detection effect.

Optionally, an included angle between at least one of the plurality of planes on which the Q photoelectric detector unit subarrays are located and the second plane is 120° to 150°. Further, optionally, an included angle between any one of the plurality of planes on which the Q photoelectric detector unit subarrays are located and the second plane is 120° to 150°.

Optionally, an included angle between the at least one of the plurality of planes on which the Q photoelectric detector unit subarrays are located and the third plane is 120° to 150°. Further, optionally, an included angle between any one of the plurality of planes on which the Q photoelectric detector unit subarrays are located and the third plane is 120° to 150°.

Optionally, a plane formed by projections, on a specific plane, of the photosensitive surfaces formed by the photoelectric detectors in the K photoelectric detector unit subarrays and projections, on the specific plane, of photosensitive surfaces formed by photoelectric detectors in the Q photoelectric detector unit subarrays is continuous. That is, the photosensitive surfaces formed by the photoelectric detectors in the K photoelectric detector unit subarrays and the photosensitive surfaces formed by the photoelectric detectors in the Q photoelectric detector unit subarrays are complementary to each other. Similarly, a plane formed by projections, on a specific plane, of the photosensitive surfaces formed by the photoelectric detectors in the P photoelectric detector unit subarrays and projections, on the specific plane, of the photosensitive surfaces formed by the photoelectric detectors in the Q photoelectric detector unit subarrays is continuous. That is, the photosensitive surfaces formed by the photoelectric detectors in the P photoelectric detector unit subarrays and the photosensitive surfaces formed by the photoelectric detectors in the Q photoelectric detector unit subarrays are complementary to each other.

In a possible implementation of the first aspect, the apparatus further includes X photoelectric detector unit subarrays.

The X photoelectric detector unit subarrays are located outside a region in which the N photoelectric detector unit subarrays are located, and photosensitive surfaces of photoelectric detectors in the X photoelectric detector unit subarrays are greater than photosensitive surfaces of photoelectric detectors in the N photoelectric detector unit subarrays.

Optionally, the X photoelectric detector unit subarrays are located on a plurality of planes, the plurality of planes are not coplanar with the second plane, and the plurality of planes are not coplanar with the third plane.

Optionally, an included angle between at least one of the plurality of planes on which the X photoelectric detector unit subarrays are located and the second plane is 150° to 180°. Further, optionally, an included angle between any one of the plurality of planes on which the X photoelectric detector unit subarrays are located and the second plane is 150° to 180°.

Optionally, an included angle between the at least one of the plurality of planes on which the X photoelectric detector unit subarrays are located and the third plane is 150° to 180°. Further, optionally, an included angle between any one of the plurality of planes on which the X photoelectric detector unit subarrays are located and the third plane is 150° to 180°.

In a possible implementation of the first aspect, the apparatus further includes a lens. The lens is configured to: process a received initial optical signal to obtain the optical signal, and output the optical signal to the N photoelectric detector unit subarrays.

In a possible implementation of the first aspect, the apparatus further includes a processor. The processor is connected to the M output ports, and is configured to receive the first electrical signal, and determine, based on the first electrical signal, data carried by the first electrical signal.

Optionally, the data carried by the first electrical signal includes communication data and/or positioning data.

In a possible implementation of the first aspect, the apparatus further includes an amplifier and a processor. One end of the amplifier is connected to the M output ports, and is configured to receive the first electrical signal. The amplifier is configured to perform signal amplification on the first electrical signal, to obtain a second electrical signal. The other end of the amplifier is connected to the processor, and is configured to send the second electrical signal to the processor. The processor is configured to determine, based on the second electrical signal, data carried by the second electrical signal.

Optionally, the data carried by the second electrical signal includes communication data and/or positioning data.

In a possible implementation of the first aspect, a region covered by the optical signal includes a target photoelectric detector unit subarray in the N photoelectric detector unit subarrays. The processor is further configured to control a quantity of photoelectric detector units that are in the target photoelectric detector unit subarray and that perform photoelectric conversion on the optical signal to be a variable value.

Based on the foregoing technical solution, the processor may be configured to control the quantity of photoelectric detector units that are in the target photoelectric detector unit subarray and that perform photoelectric conversion on the optical signal, so that a signal receiving gain of the signal processing apparatus can be further controlled based on control on the quantity of photoelectric detector units. In addition, signal receiving sensitivity of the signal processing apparatus is controlled based on the control on the quantity of photoelectric detector units.

In a possible implementation of the first aspect, the processor is further configured to determine, at a first moment, that the region covered by the optical signal includes a first photoelectric detector unit subarray in the N photoelectric detector unit subarrays.

The processor is further configured to sequentially control, at different moments after the first moment, photoelectric detector units in the first photoelectric detector unit subarray to perform photoelectric conversion on the optical signal, to obtain a third electrical signal. The third electrical signal is used to determine a first azimuth angle of a light source that generates the optical signal.

The processor is further configured to: at a second moment following the different moments after the first moment, move the lens by using a mobile apparatus, and determine that the region covered by the optical signal includes a second photoelectric detector unit subarray in the N photoelectric detector unit subarrays.

The processor is further configured to sequentially control, at different moments after the second moment, photoelectric detector units in the second photoelectric detector unit subarray to perform photoelectric conversion on the optical signal, to obtain a fourth electrical signal. The fourth electrical signal is used to determine a second azimuth angle of the light source that generates the optical signal.

The processor is further configured to determine, based on the first azimuth angle and the second azimuth angle, a distance between the light source of the optical signal and the apparatus.

Based on the foregoing technical solution, the processor may further adjust the lens (such as a location of the lens and an orientation of the lens), and calculate a distance from the light source to the signal processing apparatus based on corresponding electrical signals generated by optical signals processed by the lens at different moments and with reference to lens-related parameters (such as a focus location and a moving distance of a focus on a focal plane), to implement high-precision AOA positioning.

Optionally, the mobile apparatus includes a micro-electro-mechanical system (MEMS).

In a possible implementation of the first aspect, the processor is further configured to determine that the region covered by the optical signal includes a third photoelectric detector unit subarray in the N photoelectric detector unit subarrays. The processor is further configured to control a fourth photoelectric detector unit subarray adjacent to the third photoelectric detector unit subarray to receive the optical signal, to obtain a fifth electrical signal. The processor is further configured to determine a movement path of the light source of the optical signal based on the fifth electrical signal.

Based on the foregoing technical solution, in a moving process of the light source, a location at which the optical signal generated by the light source is irradiated on the N photoelectric detector unit subarrays may be caused to move accordingly, and the processor may track a moving path of the light source based on a change of an electrical signal generated by the movement.

A second aspect of this disclosure provides a signal processing apparatus, including a plurality of arrays. At least one of the plurality of arrays includes the N photoelectric detector unit subarrays, and the M output ports respectively connected to the N photoelectric detector unit subarrays according to any one of the first aspect and the possible implementations of the first aspect.

It should be understood that, in addition to the N photoelectric detector unit subarrays and the M output ports respectively connected to the N photoelectric detector unit subarrays according to any one of the first aspect and the possible implementations of the first aspect, the at least one of the plurality of arrays further includes at least one of the lens, the controller, the amplifier, the processor and the like shown in the first aspect, and implements corresponding technical effects.

In a possible implementation of the second aspect, any one of the plurality of arrays includes the N photoelectric detector unit subarrays, and the M output ports respectively connected to the N photoelectric detector unit subarrays according to any one of the first aspect and the possible implementations of the first aspect.

In a possible implementation of the second aspect, photoelectric detector unit subarrays included in an array in the plurality of arrays other than the at least one array are different from the N photoelectric detector unit subarrays in any one of the first aspect and the possible implementations of the first aspect.

A third aspect of this disclosure provides a signal receiver. The signal receiver includes the signal processing apparatus according to any one of the first aspect and the possible implementations of the first aspect, or the signal receiver includes the signal processing apparatus according to any one of the second aspect and the possible implementations of the second aspect.

A fourth aspect of this disclosure provides a signal processing device. The signal processing device includes a light source (or referred to as a transmitter, a signal transmitter, an optical signal transmitter, or the like), and the signal processing apparatus according to any one of the first aspect and the possible implementations of the first aspect.

For technical effects brought by the second aspect to the fourth aspect and the possible implementations of the second aspect to the fourth aspect, refer to the technical effects brought by the first aspect and the possible implementations of the first aspect.

### BRIEF DESCRIPTION OF DRAWINGS

FIG. 1 is a diagram of an example optical wireless communication (OWC) receiver;

FIG. 2 is another diagram of an example OWC receiver;

FIG. 3 is a diagram of a signal processing apparatus according to an example embodiment of this disclosure;

FIG. 4 is a diagram of an array pattern in a signal processing apparatus according to an example embodiment of this disclosure;

FIG. 5 is a diagram of an array pattern in a signal processing apparatus according to an example embodiment of this disclosure;

FIG. 6a is a diagram of an array pattern in a signal processing apparatus according to an example embodiment of this disclosure;

FIG. 6b is a diagram of an array pattern in a signal processing apparatus according to an example embodiment of this disclosure;

FIG. 6c is a diagram of an array pattern in a signal processing apparatus according to an example embodiment of this disclosure;

FIG. 6d is a diagram of an array pattern in a signal processing apparatus according to an example embodiment of this disclosure;

FIG. 6e is a diagram of an array pattern in a signal processing apparatus according to an example embodiment of this disclosure;

FIG. 6f is a diagram of an array pattern in a signal processing apparatus according to an example embodiment of this disclosure;

FIG. 7 is another diagram of a signal processing apparatus according to an example embodiment of this disclosure;

FIG. 8a is another diagram of a signal processing apparatus according to an example embodiment of this disclosure;

FIG. 8b is another diagram of a signal processing apparatus according to an example embodiment of this disclosure;

FIG. 9 is a diagram of a photoelectric detector unit in a signal processing apparatus according to an example embodiment of this disclosure;

FIG. 10 is a diagram of a circuit of a subarray in a signal processing apparatus according to an example embodiment of this disclosure;

FIG. 11a is a diagram of a working procedure of a signal processing apparatus according to an example embodiment of this disclosure;

FIG. 11b is another diagram of a working procedure of a signal processing apparatus according to an example embodiment of this disclosure;

FIG. 11c is another diagram of a working procedure of a signal processing apparatus according to an example embodiment of this disclosure;

FIG. 11d is another diagram of a working procedure of a signal processing apparatus according to an example embodiment of this disclosure;

FIG. 12 is another diagram of a signal processing apparatus according to an example embodiment of this disclosure;

FIG. 13a is another diagram of a signal processing apparatus according to an example embodiment of this disclosure;

FIG. 13b is another diagram of a signal processing apparatus according to an example embodiment of this disclosure;

FIG. 14 is another diagram of a signal processing apparatus according to an example embodiment of this disclosure; and

FIG. 15 is another diagram of a signal processing apparatus according to an example embodiment of this disclosure.

### DESCRIPTION OF EMBODIMENTS

The following describes technical solutions in embodiments of this disclosure with reference to accompanying drawings in embodiments of this disclosure.

In descriptions of this disclosure, unless otherwise specified, “/” means “or”. For example, A/B may indicate A or B. In this specification, “and/or” is merely an association relationship for describing associated objects and represents that at least three relationships may exist. For example, A and/or B may indicate the following three cases: Only A exists, both A and B exist, and only B exists. In addition, “at least one” means one or more, and “a plurality of” means two or more. “At least one of the following items (pieces)” or a similar expression thereof means any combination of these items, including any combination of singular items (pieces) or plural items (pieces). For example, at least one of a, b, or c may indicate a, b, c, a and b, a and c, b and c, or a, b, and c. a, b, and c may be singular or plural.

In the descriptions of this disclosure, terms such as “first” and “second” do not limit a quantity and an execution sequence, and the terms such as “first” and “second” do not indicate a definite difference.

In this disclosure, terms such as “example”, “for example” or the like represent giving an example, an illustration, or a description. Any embodiment or implementation scheme described with “example”, “in an example”, or “for example” in this disclosure should not be explained as being more preferred or having more advantages than another embodiment or implementation scheme. Exactly, use of the terms “example”, “in an example”, “for example”, or the like is intended to present a related concept in a specific manner.

In this disclosure, unless otherwise specified, for same or similar parts of embodiments or implementations, refer to each other. In embodiments of this disclosure and the implementations/implementation methods in embodiments, unless otherwise specified or a logical conflict occurs, terms and/or descriptions are consistent and may be mutually referenced between different embodiments and between the implementations/implementation methods in embodiments. Technical features in the different embodiments and the implementations/implementation methods in embodiments may be combined to form a new embodiment, implementation, or implementation method based on an internal logical relationship thereof. The following implementations of this disclosure are not intended to limit the protection scope of this disclosure.

The optical wireless communication technology is one of key fields in wireless communication technologies. Different from wireless communication systems with 5 to 6 gigahertz (GHz), 60 GHz, and terahertz (THz) frequency bands, the optical wireless communication technology has advantages such as large available bandwidth, a small transmit antenna, and anti-electromagnetic interference. The industry and academia have corresponding system solutions for scenarios such as indoor short-distance and outdoor long-distance communication, and actively carry out system-level test and demonstration and key technology exploration.

A high-speed optical wireless communication system solution is mainly used in single-user point-to-point and single-input single-output (SISO) communication scenarios. In order to implement high-speed optical wireless communication, a light source and a photoelectric detector in a current system adopt broadband devices. Usually, an active area of a broadband photoelectric detector is small, and a diameter is at an order of magnitude of micrometer (um).

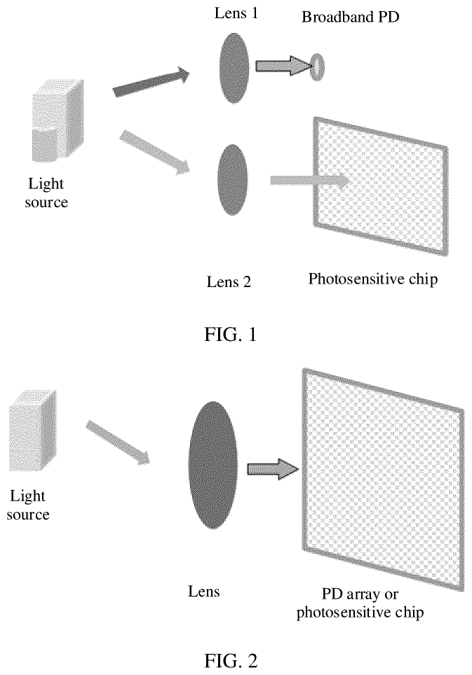

In addition, high-precision positioning and sensing performed by using an optical band (such as visible light or near infrared) is also a typical application scenario. Sensing, positioning, and even imaging becomes new features, especially in a future next-generation communication system. Currently, a plurality of commercial hardware systems such as a vehicle-mounted lidar, infrared structured light, a light-emitting diode (LED) array, and the like are applied in the above field. Typical core hardware in an optical wireless communication (OWC) receiver used for optical positioning and sensing is mainly a complementary metal-oxide-semiconductor (CMOS) photosensitive chip or a single photon avalanche diode (SPAD) array. High-resolution and superior imaging quality and high sensitivity are provided. The following describes an example of the OWC receiver in the foregoing field with reference to FIG. 1 and FIG. 2.

As shown in FIG. 1, an implementation of an OWC receiver includes a lens 1, a broadband PD, a lens 2, and a photosensitive chip. An optical signal emitted by a light source is shown by an arrow in FIG. 1. An optical signal is projected on the broadband PD after passing through the lens 1, to implement data communication. Another optical signal is projected on the photosensitive chip after passing through the lens 2, to perform positioning and imaging.

In the implementation shown in FIG. 1, two receiver systems are needed to implement positioning and sensing and high-speed communication respectively. Complexity of the systems is high. It is difficult to implement miniaturization and improve integration, and there is no advantage in costs.

As shown in FIG. 2, an implementation of another OWC receiver includes a lens, a PD array (or a photosensitive chip). An optical signal emitted by a light source is shown by an arrow in FIG. 2. The optical signal is projected to the PD array after passing through the lens, and the PD array implements signal processing and positioning. A typical PD array solution includes a CMOS photosensitive chip, an SPAD array and the like.

In the implementation shown in FIG. 2, a CMOS photosensitive chip and an SPAD array need to be used. A frame rate or bandwidth of the device is limited, and a high-speed communication requirement cannot be met.

In addition, both the broadband PD and the photosensitive chip shown in FIG. 1 and the PD array shown in FIG. 2 include a large quantity of photoelectric detectors, configured to perform photoelectric conversion to generate an electrical signal. A photoelectric detector array formed by the photoelectric detectors includes a plurality of photoelectric detectors and electrical signal output ports that are in one-to-one correspondence with the plurality of photoelectric detectors, so that the signal receiver obtains an electrical signal obtained by each photoelectric detector.

However, in a current OWC receiver system, a large-scale PD array (e.g. CMOS photosensitive chip) has low bandwidth, and for a broadband PD array, complexity is high and a scale is limited. As a result, a problem that communication and positioning and sensing cannot be compatible with hardware is not resolved. In addition, in the foregoing implementation, because a corresponding electrical signal output port needs to be disposed for each photoelectric detector, complexity of the photoelectric detector array is high.

Therefore, this disclosure provides a signal processing apparatus, configured to enable the signal processing apparatus to have functions of communication and positioning and sensing, so that complexity of a photoelectric detector array is reduced.

The signal processing apparatus provided in this disclosure may be applied to an optical wireless communication system, and has unique advantages and competitiveness, especially in a scenario in which real-time tracking and dynamic high-speed communication are needed. An AoA and a location of a peer OWC transmitter can be determined in real time, and a transmit/receive light beam can be adjusted in real time, thereby ensuring stability and reliability of a communication link in a high-speed movement scenario.

It should be understood that the signal processing apparatus provided in this disclosure may be applied to communication, positioning, (light source) path tracking, or another scenario in a wireless optical signal processing process. This is not limited herein.

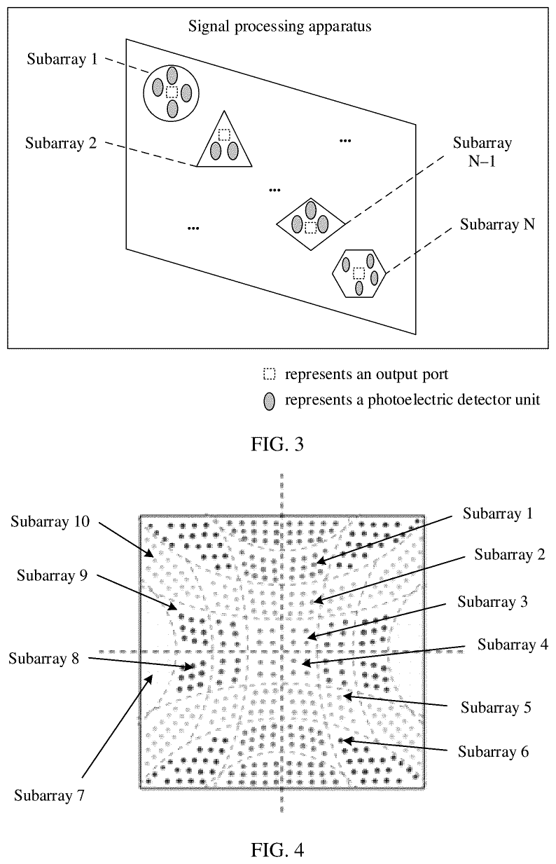

FIG. 3 is a diagram of an implementation of the signal processing apparatus provided in this disclosure. The signal processing apparatus includes N photoelectric detector unit subarrays and M output ports respectively connected to the N photoelectric detector unit subarrays, where at least two of the N photoelectric detector unit subarrays are different, a quantity of photoelectric detector units included in at least one of the N photoelectric detector unit subarrays is greater than or equal to 2, N is an integer greater than or equal to 2, and M is an integer less than or equal to N; a photoelectric detector unit in the N photoelectric detector unit subarrays is configured to perform photoelectric conversion on an optical signal, to obtain a first electrical signal; and the M output ports are configured to output the first electrical signal.

Specifically, in the signal processing apparatus shown in FIG. 3, a quantity of photoelectric detector unit subarrays is N, a quantity of output interfaces connected to the N photoelectric detector unit subarrays is M, and M is an integer less than or equal to N. That is, the quantity of output interfaces is less than or equal to the quantity of photoelectric detector unit subarrays. In addition, the quantity of photoelectric detector units included in the at least one of the N photoelectric detector unit subarrays is greater than or equal to 2. In other words, the quantity of output interfaces is less than a quantity of photoelectric detectors. Therefore, there is no need to dispose a corresponding electrical signal output port for each photoelectric detector, so that complexity of a photoelectric detector array is reduced. In addition, because the at least two of the N photoelectric detector unit subarrays are different, an arrangement of photoelectric detector units in different photoelectric detector unit subarrays is more flexible.

It should be noted that the photoelectric detector in this disclosure may include one or more of a photodiode (PD), a PIN photodiode (PIN-PD), and an avalanche photodiode (APD).

It should be understood that, in FIG. 3 and the following implementations, a circle, a triangle, a diamond, and a hexagon are used to respectively represent a subarray 1, a subarray 2, a subarray N−1, and a subarray N. During actual application, geometric shapes used by different subarrays may alternatively be a rectangle, a trapezoid, a barrel shape, a ring shape, a honeycomb shape, or another regular or irregular pattern. This is not limited herein. In addition, in FIG. 3 and the following implementations, an example in which a shape of an array formed by the N subarrays is a parallelogram is used for description. During actual application, the shape of the array formed by the N subarrays may alternatively be a rectangle, a circle, or another regular or irregular pattern. This is not limited herein.

In addition, M is an integer less than or equal to N. When M is an integer equal to N, the N photoelectric detector unit subarrays are in a one-to-one correspondence with the M output ports. When M is an integer less than N, the at least two of the N photoelectric detector unit subarrays correspond to a same output port in the M output ports.

The following describes a plurality of implementations of the array formed by the N subarrays.

In the implementation shown in FIG. 3, that at least two of the N photoelectric detector unit subarrays are different includes at least one of the following:
shapes of the at least two of the N photoelectric detector unit subarrays are different;
areas of the at least two of the N photoelectric detector unit subarrays are different;
quantities of photoelectric detector units included in the at least two of the N photoelectric detector unit subarrays are different;
areas of photosensitive surfaces of photoelectric detectors included in the at least two of the N photoelectric detector unit subarrays are different; or
spacings (or sparseness degrees) between photoelectric detector units included in the at least two of the N photoelectric detector unit subarrays are different.

Specifically, in the N photoelectric detector unit subarrays in the signal processing apparatus, at least one of the shapes, the areas, the quantities of included photoelectric detector units, the areas of photosensitive surfaces of included photoelectric detectors, and the spacings between included photoelectric detector units of the at least two photoelectric detector unit subarrays are different. During actual application, because the optical signal may not be evenly irradiated in the N photoelectric detector unit subarrays, the photoelectric detector unit subarray may be flexibly configured based on an application scenario.

It should be understood that “irradiation” in this disclosure may also be replaced with focusing, projection, coverage, or the like.

For example, in an implementation shown in FIG. 4, a closed region formed by adjacent dashed lines may be considered as a subarray, and a solid point in the closed region may represent a “photoelectric detector unit”. For example, the N subarrays in FIG. 3 include at least “a subarray 1, a subarray 2, . . . , and a subarray 10” indicated in FIG. 4. Areas corresponding to the subarray 3 and the subarray 4 are the same, areas corresponding to the subarray 8 and the subarray 9 are the same, and areas of other subarrays are different. Because the optical signal projected on the N subarrays may be processed by a lens, an optical signal that is relatively parallel (or has a small included angle) to a focal plane of the lens is projected on a central region of an array shown in FIG. 4, and an optical signal that is not relatively parallel (or has a large included angle) to the focal plane of the lens is projected on an edge region of the array shown in FIG. 4. Therefore, an area of a region close to the central region may be set to be small, and an area of a region close to the edge region may be set to be large. In this way, high signal sensing sensitivity is implemented, so that high average sensing precision is implemented for the photoelectric detector units when the photoelectric detector units are arranged at a same density.

In a possible implementation, photosensitive surfaces of an array formed by the N photoelectric detector unit subarrays are axisymmetrically distributed. Specifically, the photosensitive surfaces of the array formed by the N photoelectric detector unit subarrays are axisymmetrically distributed, so that a processing capability corresponding to an optical signal received by the signal processing apparatus at a specific angle on one side of an axis is the same or similar to a processing capability corresponding to an optical signal received by the signal processing apparatus at the angle on the other side of the axis.

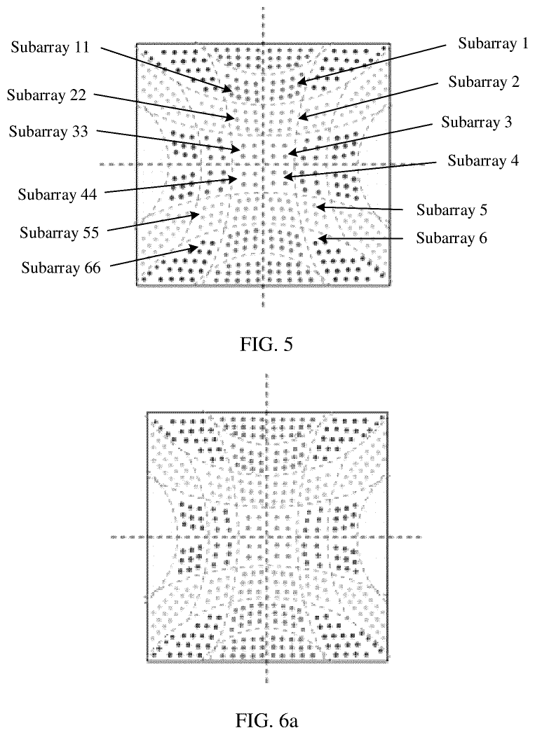

For example, refer to FIG. 5. An example in which an array pattern formed by the N photoelectric detector unit subarrays is a pattern shown in FIG. 4 is still used herein. In FIG. 5, an axis in a vertical direction of the array is used as an example. A “subarray 1” and a “subarray 11”, a “subarray 2” and a “subarray 22”, a “subarray 3” and a “subarray 33”, a “subarray 4” and a “subarray 44”, a “subarray 5” and a “subarray 55”, and a “subarray 6” and a “subarray 66” are all axisymmetric.

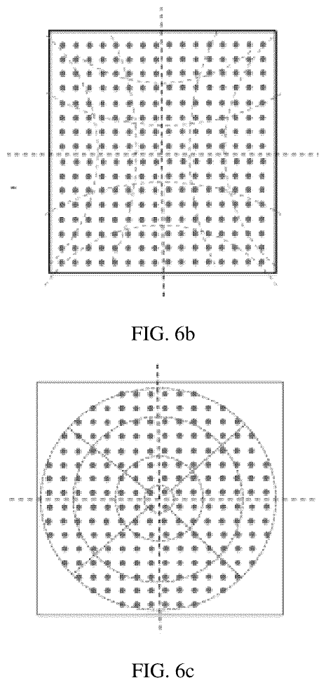

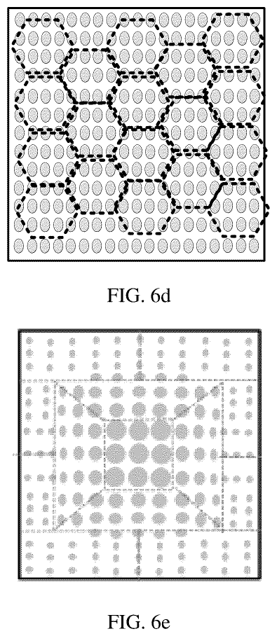

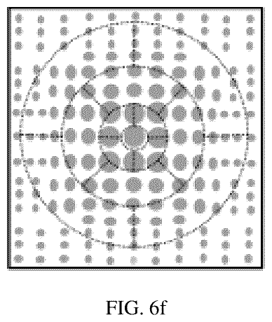

It can be learned from the foregoing implementation process that at least two of the N subarrays are different. Therefore, the array formed by the N subarrays may also be referred to as an irregular array. The irregular array formed by the N subarrays mainly uses light spot patterns formed by the optical signal at different incident angles, to design a subarray scale and an arrangement manner in the irregular array. A specific implementation includes but is not limited to different photoelectric detector unit arrangements, regular photoelectric detector unit arrangements with different electrical connections, an array formed by photoelectric detector units of different sizes, and the like. The following further describes examples with reference to FIG. 6a to FIG. 6f.

A pattern shown in FIG. 6a is as follows: Photoelectric detector units are irregularly arranged (spacings between the photoelectric detector units are different, and the photoelectric detector units are irregularly arranged), and photosensitive surfaces of the photoelectric detector units are of a same size. All the photoelectric detector units in the irregular array are not arranged into a straight line. A specific arrangement matches a shape and an area of a subarray region.

A pattern shown in FIG. 6b is as follows: Photoelectric detector units are regularly arranged (spacings between the photoelectric detector units are the same, and the photoelectric detector units are neatly arranged in rows and columns), and electrical domain connections of the photoelectric detector units are irregular (namely, a barrel-shaped pattern).

A pattern shown in FIG. 6c is as follows: Photoelectric detector units are regularly arranged (spacings between the photoelectric detector units are the same, and the photoelectric detector units are neatly arranged in rows and columns), and electrical domain connections of the photoelectric detector units are irregular (namely, a ring-shaped pattern). All photoelectric detector units in the irregular array are arranged in an axisymmetric pattern in rows and columns. Photosensitive surfaces of the photoelectric detector units are of a same size. Spacings between the photoelectric detector units are the same. Sizes and shapes of the subarrays are divided by using an electrical network.

A pattern shown in FIG. 6d is as follows: Photoelectric detector units are regularly arranged (spacings between the photoelectric detector units are the same, and the photoelectric detector units are neatly arranged in rows and columns), and electrical domain connections of the photoelectric detector units are irregular (namely, a honeycomb-shaped pattern).

A pattern shown in FIG. 6e is as follows: Photoelectric detector units are regularly arranged (spacings between the photoelectric detector units are different, and the photoelectric detector units are neatly arranged in rows and columns), and electrical domain connections of the photoelectric detector units are irregular (namely, a rectangular pattern). Photoelectric detector units of different sizes are used together.

A pattern shown in FIG. 6f is as follows: Photoelectric detector units are regularly arranged (spacings between the photoelectric detector units are different, and the photoelectric detector units are neatly arranged in rows and columns), and electrical domain connections of the photoelectric detector units are irregular (namely, a ring-shaped pattern). Photoelectric detector units of different sizes are used together. All photoelectric detector units in the irregular array are arranged in an axisymmetric pattern. Photoelectric detector units of a subarray in a central region have large photosensitive surfaces, and are arranged closely. Photoelectric detector units of a subarray in an edge region have small photosensitive surfaces, and are sparsely arranged.

Based on the implementations shown in FIG. 6a to FIG. 6f, it may be obtained that the irregular array has at least one of the following features:
a. At least two photoelectric detector unit subarrays are combined, and photosensitive surfaces of the irregular array formed by the photoelectric detector unit subarrays are axisymmetrically distributed.
b. A photo-generated current of the photoelectric detector unit subarrays is output by an electrical signal interface, a quantity of electrical signal interfaces is equal to a quantity of photoelectric detector unit subarrays, and is less than a quantity of photoelectric detector units in the irregular array. A scale of the photoelectric detector unit subarrays is greater than 1.
c. The photoelectric detector unit subarrays in the irregular array include at least two array patterns or areas.
d. The photoelectric detector unit subarrays in the irregular array include at least two array scales (where the array scale is a quantity of photoelectric detector units in the photoelectric detector unit subarrays), and a scale of a photoelectric detector unit subarray located at an edge of the irregular array is greater than or equal to 2.
e. Among the photoelectric detector unit subarrays in the irregular array, scales of photoelectric detector unit subarrays located in a central region of the irregular array are small, and scales of photoelectric detector unit subarrays close to the edge of the array are large. That is, a larger distance from the central area of the array indicates increasing scales of the photoelectric detector unit subarrays.

In conclusion, selection of an irregular pattern may be adapted with reference to an optical feature of the lens, and scales, patterns, or areas of the photoelectric detector unit subarrays in the irregular array may not be unique.

The foregoing describes the N subarrays in the signal processing apparatus shown in FIG. 3. The following further describes the signal processing apparatus with reference to more accompanying drawings.

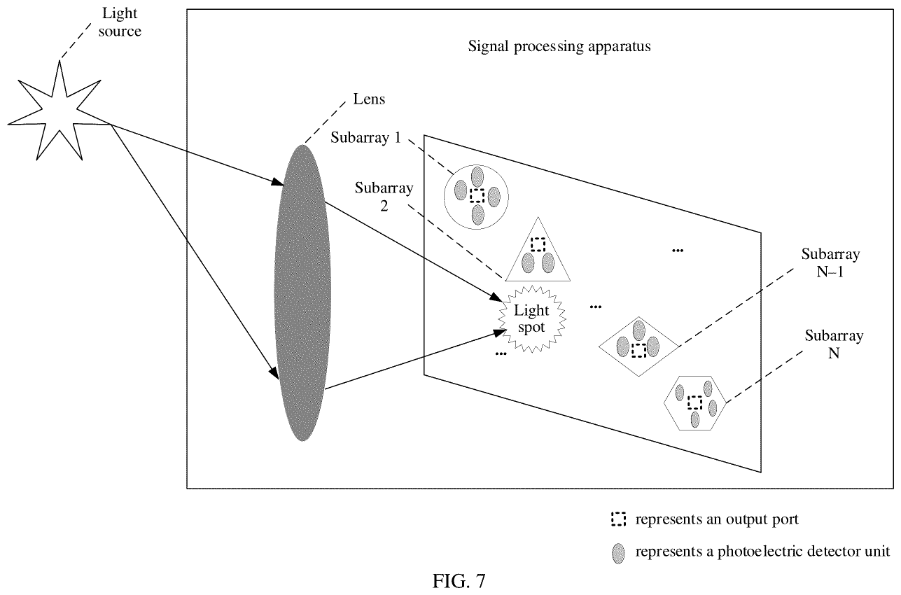

In a possible implementation, as shown in FIG. 7, based on the implementation shown in FIG. 3, the signal processing apparatus may further include a lens. The lens is configured to receive an initial optical signal from a light source, and after the lens processes the optical signal (such as focusing or refraction), the obtained optical signal is emitted into the array formed by the N subarrays, to form a light spot, so that the array formed by the N subarrays performs photoelectric conversion on data carried by the light spot, to obtain an electrical signal, and then outputs the electrical signal through one or more of the M ports.

Optionally, a main function of the lens is to focus an optical signal emitted by the light source, and project, to the irregular array, a light spot formed by focusing. A specific implementation includes but is not limited to a convex lens, a lens group, a supersurface lens, and the like. In addition, an MEMS structure may be optionally configured for the lens, to adjust a specific location and a tilt angle of the lens.

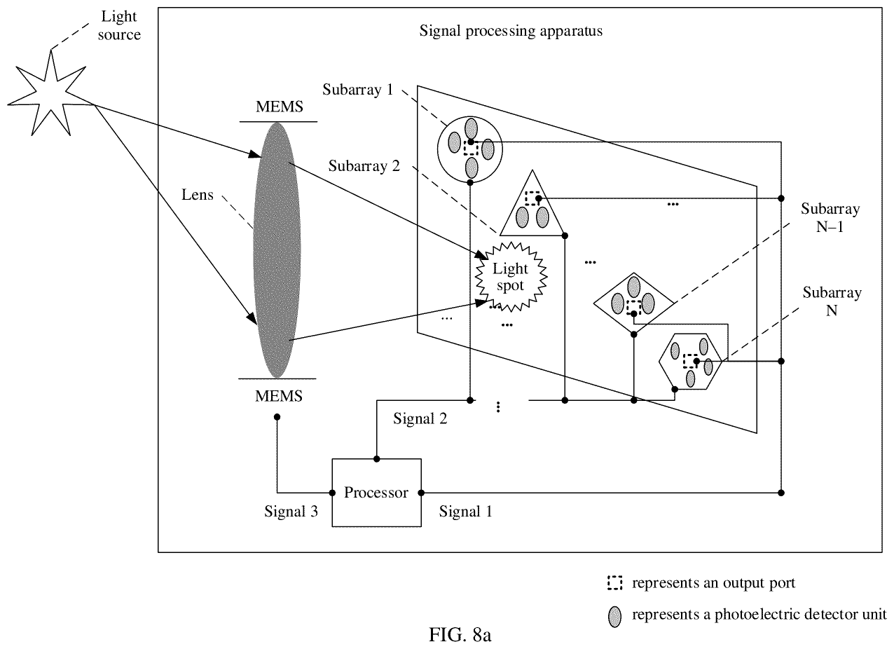

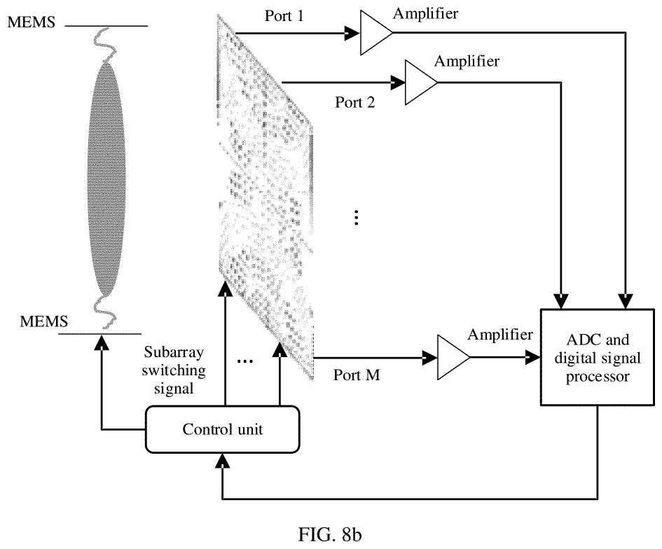

Further, as shown in FIG. 8a, based on the implementation shown in FIG. 7, the signal processing apparatus may further include one or more processors.

In an implementation, the processor shown in FIG. 8a may be connected to the M ports, communicate with the M ports by using a link of a “signal 1” in FIG. 8a, receive an electrical signal output by the one or more of the M ports, and decode the electrical signal, to determine data carried by the optical signal. In other words, the signal processing apparatus shown in FIG. 7 further includes a processor. The processor is connected to the M output ports, and is configured to receive the first electrical signal, and determine, based on the first electrical signal, data carried by the first electrical signal.

In another implementation, the processor shown in FIG. 8a may be connected to the array formed by the N subarrays, and communicate, by using a link of a “signal 2” in FIG. 8a, with a photoelectric detector unit in the array formed by the N subarrays, to control a working mode of the photoelectric detector unit in the array formed by the N subarrays.

In another implementation, the processor shown in FIG. 8a may be connected to a mobile apparatus (namely, an MEMS) corresponding to the lens, and communicate with the mobile apparatus corresponding to the lens by using a link of a “signal 3” in FIG. 8a, to control the mobile apparatus corresponding to the lens, so as to control an orientation of the lens.

In a possible implementation, the “processor” shown in FIG. 8a may include a plurality of parts, for example, a “control unit” and an “analog-to-digital converter (ADC) and digital signal processor” shown in FIG. 8b.

As shown in FIG. 8b, the “control unit” may be connected to the M ports by sequentially using an “ADC and digital signal processor” module and an “amplifier” module, to implement an implementation corresponding to the “signal 1” in FIG. 8a. In other words, the signal processing apparatus shown in FIG. 8a further includes an amplifier and a processor. One end of the amplifier is connected to the M output ports, and is configured to receive the first electrical signal. The amplifier is configured to perform signal amplification on the first electrical signal, to obtain a second electrical signal. The other end of the amplifier is connected to the processor, and is configured to send the second electrical signal to the processor. The processor is configured to determine, based on the second electrical signal, data carried by the second electrical signal.

As shown in FIG. 8b, the “control unit” may be separately connected to the photoelectric detector unit in the array formed by the N subarrays and the MEMS, to separately implement implementations corresponding to the “signal 2” and the “signal 3” in FIG. 8a.

The following further describes the photoelectric detector unit in this disclosure.

In a possible implementation, the photoelectric detector unit includes at least a photoelectric detector. The photoelectric detector may include one or more of a photodiode (PD), a PIN photodiode (PIN-PD), and an avalanche photodiode (APD).

Optionally, the photoelectric detector unit includes a switch and a photoelectric detector. Specifically, the photoelectric detector unit includes the switch and the photoelectric detector, so that a working mode of the photoelectric detector may be configured by using the switch. Therefore, based on control of a scheduling policy of photoelectric detectors included in the N photoelectric detector unit subarrays, application of high-precision angle of arrival (AOA) estimation and/or positioning can be implemented.

Optionally, the switch is configured to control connection or disconnection of the photoelectric detector. Therefore, based on a setting of the switch in the photoelectric detector unit, connection or disconnection may be controlled to implement switching of the working mode of the photoelectric detector.

For example, when the signal processing apparatus is used in a communication scenario, the switch in the photoelectric detector unit may be used to control a quantity of photoelectric detectors in a connected state in the photoelectric detector unit subarrays, so that a signal receiving gain of the signal processing apparatus can be controlled, and signal receiving sensitivity of the signal processing apparatus can also be controlled based on the control on the quantity of photoelectric detectors.

For another example, when the signal processing apparatus is used in a scenario such as positioning or sensing, the switch in the photoelectric detector unit may be used to control the photoelectric detectors in the photoelectric detector unit subarrays that are connected in a polling manner, and an incident angle of the optical signal is controlled with reference to control of the lens, to implement positioning or sensing of the light source.

For another example, when the signal processing apparatus is used in a light source path tracking scenario, the switch in the photoelectric detector unit may be used to control the photoelectric detectors in the photoelectric detector unit subarrays that are connected in a polling manner, and the light source path is tracked with reference to an optical signal received by an adjacent photoelectric detector unit subarray.

In a possible implementation, the photoelectric detector unit further includes an inductor and an impedance circuit. Specifically, in addition to the switch and the photoelectric detector, the photoelectric detector unit may further include the inductor and the impedance circuit, so that a circuit unit is formed when the inductor is connected to the photoelectric detector. Output impedance of the circuit unit is related to the inductor and the photoelectric detector, and has small reflection, to ensure that input/output impedance of the photoelectric detector unit is close to default input/output impedance. Similarly, a circuit unit is formed when the inductor is connected to the impedance circuit. Output impedance of the circuit unit is related to the inductor and the impedance circuit, and can also have small reflection, to ensure that the input/output impedance of the photoelectric detector unit is close to the default input/output impedance.

Optionally, the default input/output impedance may be 50 ohms or another value. This is not limited herein.

Optionally, a difference between impedance of the photoelectric detector and impedance of the impedance circuit is less than a threshold. The difference between the impedance of the photoelectric detector and the impedance of the impedance circuit is less than the threshold. That is, the impedance of the photoelectric detector is the same as or close to the impedance of the impedance circuit. In this way, input/output impedance generated by the photoelectric detector unit when the inductor is connected to the photoelectric detector is the same or close to input/output impedance generated by the photoelectric detector unit when the inductor is connected to the impedance circuit, so that in a switch switching process, it is ensured that the photoelectric detector unit subarrays have a constant or similar electrical characteristic.

Optionally, the switch is configured to control the photoelectric detector to be connected to the inductor, and control the impedance circuit to be disconnected from the inductor; or the switch is configured to control the photoelectric detector to be disconnected from the inductor, and control the impedance circuit to be connected to the inductor.

Further, optionally, the apparatus further includes a controller. The controller is configured to control, by using the switch, the photoelectric detector to be connected to the inductor, and control the impedance circuit to be disconnected from the inductor; or the controller is configured to control, by using the switch, the photoelectric detector to be disconnected from the inductor, and control the impedance circuit to be connected to the inductor. The “controller” may be the “processor” in FIG. 8a or the “control unit” in FIG. 8b, and implement a corresponding technical effect.

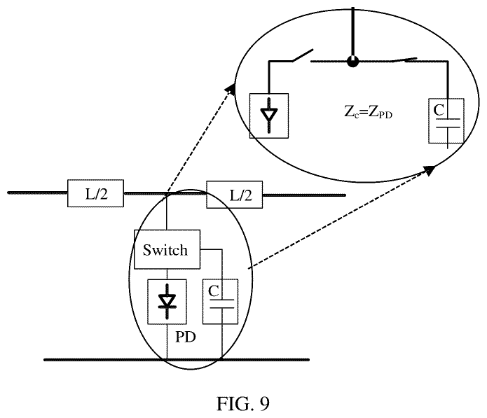

For example, a specific implementation process of the photoelectric detector unit may be implemented in a manner shown in FIG. 9. As shown in FIG. 9, a single photoelectric detector unit may include an inductor “denoted as L/2”, a switch “denoted as Switch”, a photoelectric detector “denoted as PD”, and an impedance circuit “denoted as C”. A difference between impedance of the photoelectric detector and impedance of the impedance circuit is less than a threshold. If the difference is 0, as shown in FIG. 9, the difference may be denoted as “Z_{c}=Z_{PD}”.

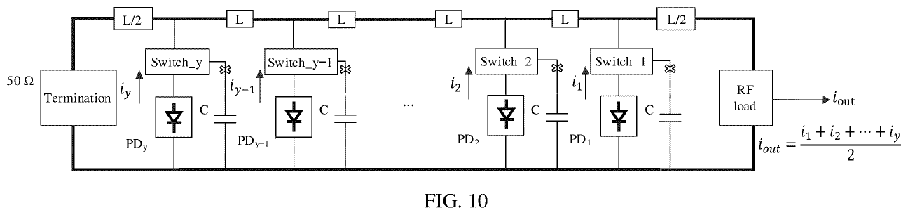

A specific implementation process of the photoelectric detector unit shown in FIG. 9 is used as an example. When a quantity of photoelectric detector units included in one of the N subarrays is y, the subarray may be represented as an implementation shown in FIG. 10.

Optionally, in FIG. 10, in addition to the y photoelectric detector units, another optional component may be further included.

For example, as shown in FIG. 10, a “terminal (termination)” located on a leftmost side is further included. The “termination” may also be referred to as an RF terminal or the like, and is an element configured to absorb energy and prevent an RF signal from being reflected back from open or unused ports, so as to absorb a photo-generated current signal that is incident to the ports.

For another example, as shown in FIG. 10, an “RF load” located on a rightmost side is further included, namely, the amplifier mentioned above. A function is to use current signals (namely, “i₁, i₂, . . . , i_{y-1}, and i_{y}” in the figure) generated by the y photoelectric detector units as input of the amplifier, and output the current signals as “iₒᵤₜ” in the figure after amplification is performed.

The foregoing describes components of the signal processing apparatus in this disclosure. The following describes an example of a working procedure of the signal processing apparatus provided in this disclosure.

In a possible implementation, the processor in the signal processing apparatus may control an irregular array gain adjustment or an AoA estimation mode, and the processor may further control a working mode of the photoelectric detector unit in the subarrays. In addition, optionally, the processor may further control an orientation and a tilt of the MEMS.

### Implementation Example 1: Communication Mode

In this implementation example, the region covered by the optical signal includes a target photoelectric detector unit subarray in the N photoelectric detector unit subarrays. The processor is further configured to control a quantity of photoelectric detector units that are in the target photoelectric detector unit subarray and that perform photoelectric conversion on the optical signal to be a variable value. Specifically, the processor may be configured to control the quantity of photoelectric detector units that are in the target photoelectric detector unit subarray and that perform photoelectric conversion on the optical signal, so that a signal receiving gain of the signal processing apparatus can be further controlled based on the quantity of photoelectric detector units. In addition, signal receiving sensitivity of the signal processing apparatus is controlled based on the control on the quantity of photoelectric detector units.

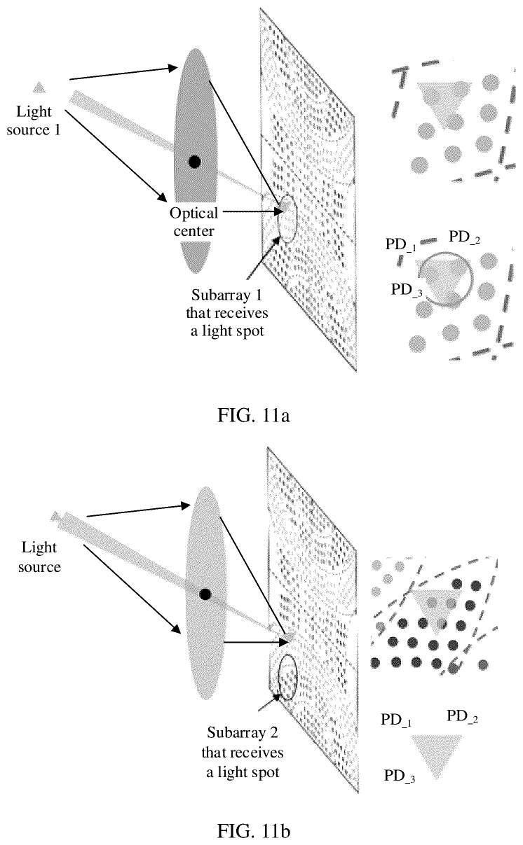

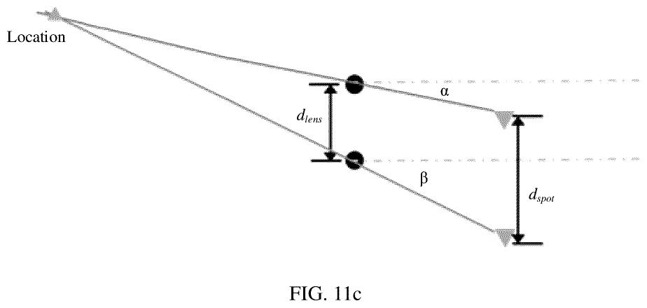

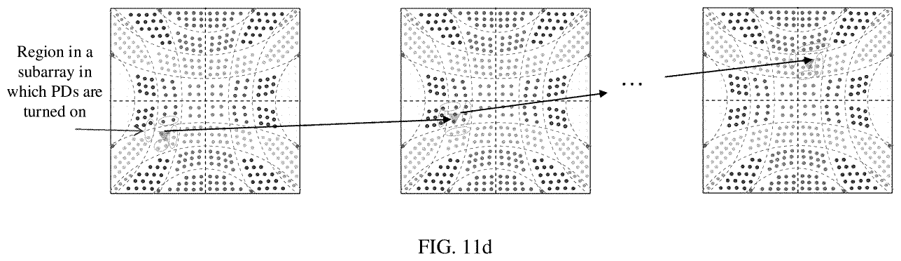

In an implementation example shown in FIG. 11a, all PDs in a subarray 1 (namely, the target photoelectric detector unit subarray) that receives the light spot are turned on to perform high-sensitivity receiving. Then, all the PDs in the subarray 1 may adjust a receiving gain of the subarray 1 based on a power and an SNR of a received signal by using a process shown in Table 1.

For example, the subarray 1 includes four photoelectric detector units. A PD 1 is close to the amplifier, PD on is defined as that the switch controls a PD branch to be connected and the impedance circuit to be disconnected, and PD off is defined as that the switch controls the PD branch to be disconnected and the impedance circuit to be connected.

TABLE 1

| | switch_4 | switch_3 | switch_2 | switch_1 |
|---|---|---|---|---|
| Gain_1 | PD on | PD off | PD off | PD off |
| Gain_2 | PD on | PD on | PD off | PD off |
| Gain_3 | PD on | PD on | PD on | PD off |
| Gain_4 | PD on | PD on | PD on | PD on |

As shown in Table 1, four switches are all in the PD on mode when a gain is at the maximum. In a gain adjustment process, based on a gain requirement, a basic subarray unit close to the amplifier is preferentially configured to be in the PD off mode. Consistency of frequency responses of the subarrays can be improved during the gain adjustment process.

### Implementation Example 2: AOA/Positioning Mode

In this implementation example, the processor in the signal processing apparatus is further configured to determine, at a first moment, that the region covered by the optical signal includes a first photoelectric detector unit subarray in the N photoelectric detector unit subarrays.

The processor is further configured to sequentially control, at different moments after the first moment, photoelectric detector units in the first photoelectric detector unit subarray to perform photoelectric conversion on the optical signal, to obtain a third electrical signal. The third electrical signal is used to determine a first azimuth angle of a light source that generates the optical signal.

The processor is further configured to: at a second moment following the different moments after the first moment, move a lens by using a mobile apparatus, and determine that the region covered by the optical signal includes a second photoelectric detector unit subarray in the N photoelectric detector unit subarrays.

The processor is further configured to sequentially control, at different moments after the second moment, photoelectric detector units in the second photoelectric detector unit subarray to perform photoelectric conversion on the optical signal, to obtain a fourth electrical signal. The fourth electrical signal is used to determine a second azimuth angle of the light source that generates the optical signal.

The processor is further configured to determine, based on the first azimuth angle and the second azimuth angle, a distance between the light source of the optical signal and the apparatus.

It should be noted that the region covered by the optical signal may include one or more of the N photoelectric detector unit subarrays. Correspondingly, there may be one or more photoelectric detector unit subarrays corresponding to the first photoelectric detector unit subarray. Similarly, there may be one or more photoelectric detector unit subarrays corresponding to the second photoelectric detector unit subarray.

In addition, in the foregoing implementation process, when the lens is moved by using the mobile apparatus, a part or all of the region covered by the optical signal may still be located in the first photoelectric detector unit subarray. Correspondingly, photoelectric detector units included in the second photoelectric detector unit subarray may be a subset of photoelectric detector units included in the first photoelectric detector unit subarray; or photoelectric detector units included in the second photoelectric detector unit subarray may have a same part as photoelectric detector units included in the first photoelectric detector unit subarray; or photoelectric detector units included in the second photoelectric detector unit subarray may be completely different from photoelectric detector units included in the first photoelectric detector unit subarray.

Specifically, the processor in the signal processing apparatus may further adjust the lens (such as a location of the lens and the orientation of the lens), and calculate a distance from the light source to the signal processing apparatus based on corresponding electrical signals generated by optical signals processed by the lens at different moments and with reference to lens-related parameters (such as a focus location and a moving distance of a focus on a focal plane), to implement high-precision AOA positioning.

In implementations shown in FIG. 11b and FIG. 11c, photoelectric detector units in a subarray 2 (namely, the target photoelectric detector unit subarray) that receives the light spot are sequentially turned on, and photoelectric detector units occupied by the light spot are determined (as shown in FIG. 11b, it is assumed that a shape covered by the light spot is a triangle, and the photoelectric detector units correspond to PD_1, PD_2, and PD_3 in the figure), and an orientation a (high-precision AOA) of the light source is reversely calculated with reference to a lens optical path. Then, the location of the lens is adjusted (optionally, translation or rotation is performed without changing a distance between the lens and an array plane), a subarray occupied by the light spot is re-determined, and a new orientation β is estimated. Finally, a relative location (for example, a distance or an AOA) from the light source to a receiver is calculated with reference to the lens, the moving distance of the focus on the focal plane, and the orientation.

Optionally, an example in which the subarray 2 includes four photoelectric detector units is used. At each moment, only one basic unit is in the PD on mode. That is, as shown in Table 2, basic units in the subarray are turned on in the polling manner. A specific basic unit covered by the light spot is determined based on a photo-generated current output by each basic unit. Then AoA information of the light source is obtained with reference to the lens optical path.

TABLE 2

| | switch_1 | switch_2 | switch_3 | switch_4 |
|---|---|---|---|---|
| PD_1 | PD on | PD off | PD off | PD off |
| PD_2 | PD off | PD on | PD off | PD off |
| PD_3 | PD off | PD off | PD on | PD off |
| PD_4 | PD off | PD off | PD off | PD on |

### Implementation Example 3: Tracking Mode

In this implementation example, the processor in the signal processing apparatus is further configured to determine that the region covered by the optical signal includes a third photoelectric detector unit subarray in the N photoelectric detector unit subarrays. The processor is further configured to control a fourth photoelectric detector unit subarray adjacent to the third photoelectric detector unit subarray to receive the optical signal, to obtain a fifth electrical signal. The processor is further configured to determine a movement path of the light source of the optical signal based on the fifth electrical signal.

Specifically, in a moving process of the light source, a location at which the optical signal generated by the light source is irradiated on the N photoelectric detector unit subarrays may be caused to move accordingly, and the processor may track a moving path of the light source based on a change of an electrical signal generated by the movement.

In an implementation shown in FIG. 11d, photoelectric detector units in the subarray 1 are sequentially turned on, and photoelectric detector units occupied by the light spot are determined, namely, PD_1, PD_2, and PD_3 in the figure. Then, photoelectric detector units near PD_1, PD_2, and PD_3 need to be turned on (flicker at a specific frequency), to determine in real time whether the photoelectric detector units are covered by the light spot, and non-adjacent photoelectric detector units are turned off. Then, after the light spot covers a new photoelectric detector unit, photoelectric detector units adjacent to the new photoelectric detector unit need to be turned on, to track a movement path of the light source.

Based on the technical solutions shown in FIG. 3 to FIG. 11d, a light spot pattern is formed after the optical signal passes through the lens, the photoelectric detector array is divided into a plurality of subarrays, and one or more subarrays output one electrical signal. This can greatly reduce a scale of the electrical signal interface and improve sensitivity of an array receiver. In addition, the switch and the impedance circuit are introduced into the photoelectric detector unit, to ensure that port impedance of the photoelectric detector unit subarray is consistent in a mode switching process, and the inductor in the photoelectric detector unit avoids linear addition of capacitive impedance of a plurality of photoelectric detector units, so that a structure of a subarray can be maintained to have good bandwidth. Photoelectric detector units in the subarray can be independently controlled, and a direction of arrival of the light source can be further determined, to perform AoA estimation. Application in scenarios such as positioning and tracking is supported.

In the foregoing embodiments, components and a working procedure of the signal processing apparatus are described. The following further describes a spatial arrangement of the N photoelectric detector unit subarrays included in the signal processing apparatus by using examples.

In a possible implementation, the N photoelectric detector unit subarrays are located on a same plane.

In another possible implementation, the N photoelectric detector unit subarrays include K photoelectric detector unit subarrays and P photoelectric detector unit subarrays, both K and P are integers greater than or equal to 1, and a sum of K and P is less than or equal to N; and a plane formed by projections, on a first plane, of photosensitive surfaces formed by photoelectric detectors in the K photoelectric detector unit subarrays and projections, on the first plane, of photosensitive surfaces formed by photoelectric detectors in the P photoelectric detector unit subarrays is continuous.

Specifically, the N photoelectric detector unit subarrays include at least the K photoelectric detector unit subarrays and the P photoelectric detector unit subarrays. The plane formed by the projections, on the first plane, of the photosensitive surfaces formed by the photoelectric detectors in the K photoelectric detector unit subarrays and the projections, on the first plane, of the photosensitive surfaces formed by the photoelectric detectors in the P photoelectric detector unit subarrays is continuous. In other words, the photosensitive surfaces formed by the photoelectric detectors in the K photoelectric detector unit subarrays and the photosensitive surfaces formed by the photoelectric detectors in the P photoelectric detector unit subarrays are complementary to each other. Therefore, different photoelectric detector unit subarrays jointly receive the optical signal, and photosensitive surfaces corresponding to different photoelectric detector unit subarrays are complementary to each other, to reduce blind spots between different photosensitive surfaces formed by different photoelectric detector unit subarrays.

It should be understood that the first plane is any plane.

Optionally, photoelectric detector units in the K photoelectric detector unit subarrays are located on a second plane, photoelectric detector units in the P photoelectric detector unit subarrays are located on a third plane, and the second plane is not coplanar with the third plane.

Optionally, an included angle between the second plane and the third plane is 90° to 150°.

Optionally, an included angle between the second plane and the third plane is 90°.

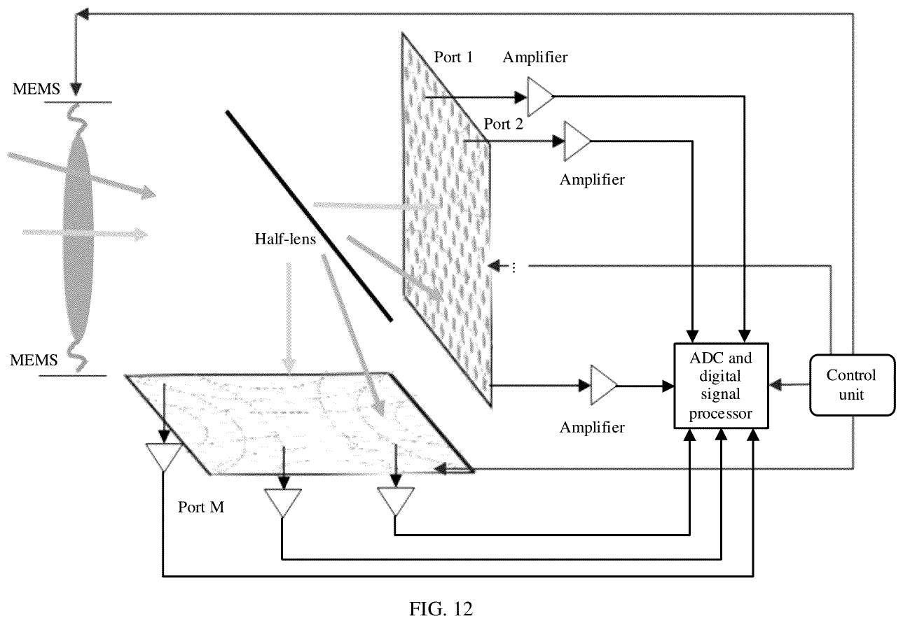

For example, in FIG. 12, an example in which the included angle between the second plane and the third plane is 90° is used for description. As shown in FIG. 12, it is assumed herein that the K photoelectric detector unit subarrays correspond to K ports, and the K photoelectric detector unit subarrays are located on a vertical plane; and the P photoelectric detector unit subarrays correspond to P ports, and the P photoelectric detector unit subarrays are located on a horizontal plane. A tilted-placed half-lens splits a light beam focused by the lens into a reflected light beam and a transmitted light beam, and the two light beams are received by two irregular arrays that are vertically placed. Therefore, the two irregular arrays are used to receive and process the optical signal. The two irregular arrays are placed vertically to each other, and photosensitive surfaces of the two irregular arrays are complementary to each other. That is, projections of photosensitive surfaces of the two irregular arrays on a plane form a continuous and complete photosensitive surface without a blind spot.

In a possible implementation, the N photoelectric detector unit subarrays further include Q photoelectric detector unit subarrays, where Q is an integer greater than or equal to 1, and a sum of K, P, and Q is less than or equal to N; and the Q photoelectric detector unit subarrays are located on a plurality of planes, the plurality of planes are not coplanar with the second plane, and the plurality of planes are not coplanar with the third plane.

Specifically, in addition to the K photoelectric detector unit subarrays and the P photoelectric detector unit subarrays, the N photoelectric detector unit subarrays may further include the Q photoelectric detector unit subarrays, where the Q photoelectric detector unit subarrays are located on the plurality of planes, the plurality of planes are not coplanar with the second plane, and the plurality of planes are not coplanar with the third plane. In this way, the plurality of planes on which the Q photoelectric detector unit subarrays are located can improve detection effect.

Optionally, an included angle between at least one of the plurality of planes on which the Q photoelectric detector unit subarrays are located and the second plane is 120° to 150°. Further, optionally, an included angle between any one of the plurality of planes on which the Q photoelectric detector unit subarrays are located and the second plane is 120° to 150°.

Optionally, an included angle between the at least one of the plurality of planes on which the Q photoelectric detector unit subarrays are located and the third plane is 120° to 150°. Further, optionally, an included angle between any one of the plurality of planes on which the Q photoelectric detector unit subarrays are located and the third plane is 120° to 150°.

Optionally, a plane formed by projections, on a specific plane, of the photosensitive surfaces formed by the photoelectric detectors in the K photoelectric detector unit subarrays and projections, on the specific plane, of photosensitive surfaces formed by photoelectric detectors in the Q photoelectric detector unit subarrays is continuous. That is, the photosensitive surfaces formed by the photoelectric detectors in the K photoelectric detector unit subarrays and the photosensitive surfaces formed by the photoelectric detectors in the Q photoelectric detector unit subarrays are complementary to each other. Similarly, a plane formed by projections, on a specific plane, of the photosensitive surfaces formed by the photoelectric detectors in the P photoelectric detector unit subarrays and projections, on the specific plane, of the photosensitive surfaces formed by the photoelectric detectors in the Q photoelectric detector unit subarrays is continuous. That is, the photosensitive surfaces formed by the photoelectric detectors in the P photoelectric detector unit subarrays and the photosensitive surfaces formed by the photoelectric detectors in the Q photoelectric detector unit subarrays are complementary to each other.

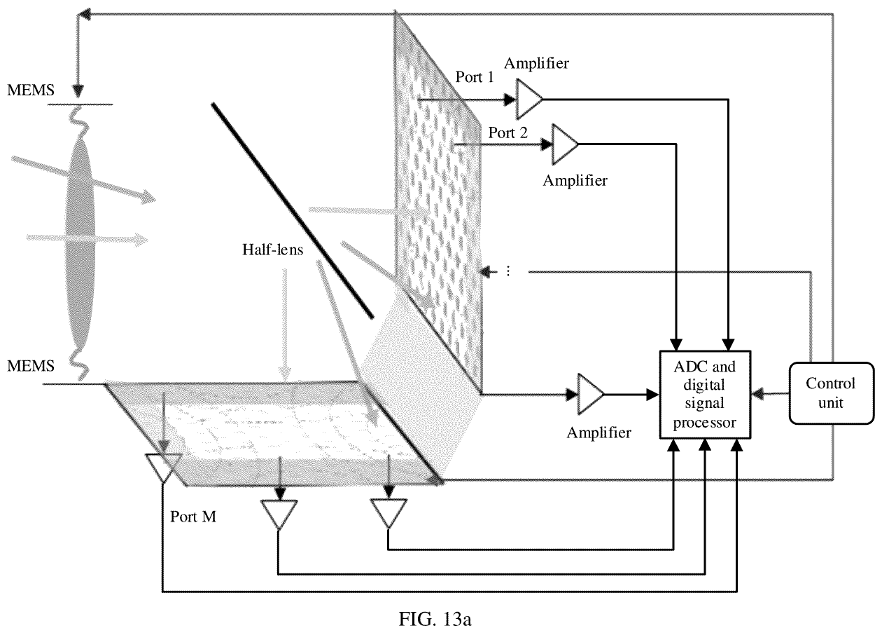

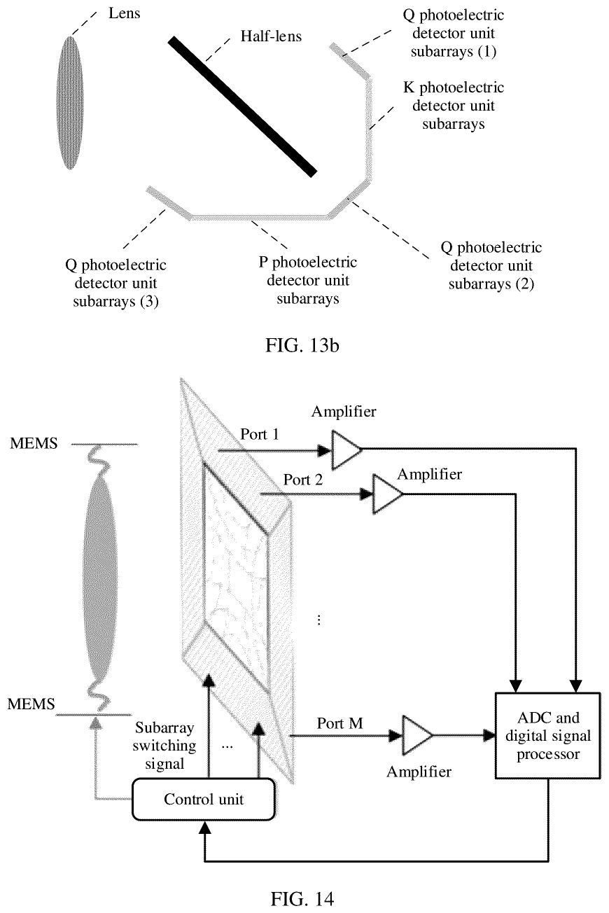

For example, in FIG. 13a, an example in which the included angle between the second plane and the third plane is 90° is used for description. In addition, in FIG. 13a, a lighter grayscale represents the “K photoelectric detector unit subarrays” and the “P photoelectric detector unit subarrays”, and a deeper grayscale represents the “Q photoelectric detector unit subarrays”. In FIG. 13a, an example in which a total quantity of PD subarrays is 2n is used for description. Further, a side view of the implementation shown in FIG. 13a may also be represented in a manner shown in FIG. 13b. In FIG. 13b, that the Q photoelectric detector unit subarrays are located on three planes is used as an example, that is, are respectively represented as “Q photoelectric detector unit subarrays (1)”, “Q photoelectric detector unit subarrays (2)”, and “Q photoelectric detector unit subarrays (3)” in FIG. 13b.

It can be learned from the implementations shown in FIG. 13a and FIG. 13b that, compared with the implementation in FIG. 12 in which the two irregular arrays are perpendicular to each other and photosensitive surfaces of the two irregular arrays are complementary to each other, a main difference lies in that an irregular array is a non-planar structure, and the Q photoelectric detector unit subarrays in the figure tilt inward by a specific angle. Therefore, when appearance of a photosensitive blind spot is reduced, and an incident angle of a light beam output by the light source is large, because the Q photoelectric detector unit subarrays tilt inward, a quantity of photoelectric detectors covered by the light spot is reduced, the detection effect is improved, and AoA estimation precision can be improved when the light beam is incident at a large angle.

In another possible implementation, the apparatus further includes X photoelectric detector unit subarrays.

The X photoelectric detector unit subarrays are located outside a region in which the N photoelectric detector unit subarrays are located, and photosensitive surfaces of photoelectric detectors in the X photoelectric detector unit subarrays are greater than photosensitive surfaces of photoelectric detectors in the N photoelectric detector unit subarrays.

Optionally, because the photosensitive surfaces of the photoelectric detectors in the X photoelectric detector unit subarrays are greater than the photosensitive surfaces of the photoelectric detectors in the N photoelectric detector unit subarrays, the X photoelectric detector unit subarrays may be referred to as narrowband PDs, and the N photoelectric detector unit subarrays may be referred to as broadband PDs.

Optionally, the X photoelectric detector unit subarrays are located on a plurality of planes, the plurality of planes are not coplanar with the second plane, and the plurality of planes are not coplanar with the third plane.

Optionally, an included angle between at least one of the plurality of planes on which the X photoelectric detector unit subarrays are located and the second plane is 150° to 180°. Further, optionally, an included angle between any one of the plurality of planes on which the X photoelectric detector unit subarrays are located and the second plane is 150° to 180°.

Optionally, an included angle between the at least one of the plurality of planes on which the X photoelectric detector unit subarrays are located and the third plane is 150° to 180°. Further, optionally, an included angle between any one of the plurality of planes on which the X photoelectric detector unit subarrays are located and the third plane is 150° to 180°.

For example, in FIG. 14, a difference from the foregoing embodiment is that a narrowband PD subarray is configured on a periphery based on the irregular array, for example, four trapezoidal parts in FIG. 14, to expand a light receiving area of the array. Therefore, an irregular array area is expanded by using the narrowband PD subarray on the periphery, a lens movement in a large range is supported, a light spot receiving range is improved, and AoA positioning precision in this structure is improved.

This disclosure further provides a signal processing apparatus, including a plurality of arrays. At least one of the plurality of arrays includes the N photoelectric detector unit subarrays, and the M output ports respectively connected to the N photoelectric detector unit subarrays in any one of the possible implementations in FIG. 3 to FIG. 14.

It should be understood that, in addition to the N photoelectric detector unit subarrays and the M output ports respectively connected to the N photoelectric detector unit subarrays in FIG. 3 to FIG. 14, the at least one of the plurality of arrays further includes at least one of the lens, the controller, the amplifier, the processor, and the like shown in the first aspect, and implements corresponding technical effects.

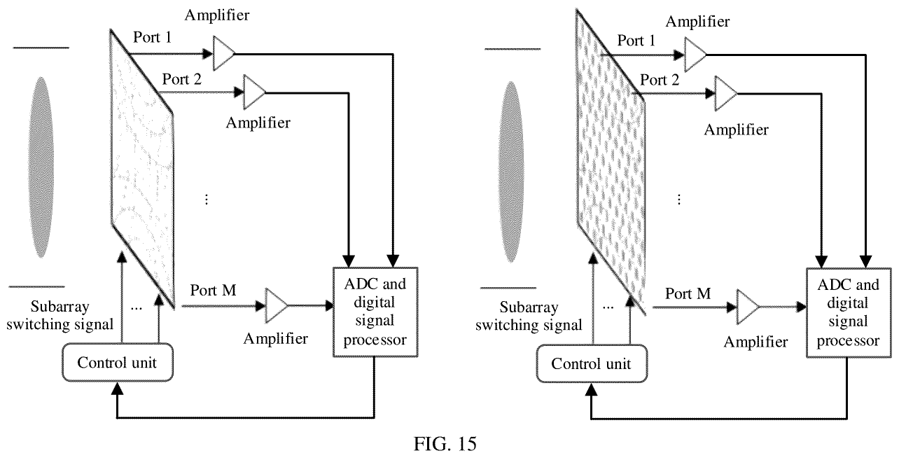

For example, an implementation in which “the plurality of arrays” are two arrays (both include the N photoelectric detector unit subarrays and the M output ports respectively connected to the N photoelectric detector unit subarrays) is used as an example, namely, a binocular configuration. An implementation process of the binocular configuration may be implemented in a manner shown in FIG. 15. In this way, a correlation of AOAs between subarrays can be reduced, and positioning precision can be improved. In addition, in an implementation of the binocular configuration, a distance between the two irregular arrays can be extended, positioning precision based on the AoA can be improved, and the two complementary irregular arrays reduce the blind spot.

In a possible implementation, any one of the plurality of arrays includes the N photoelectric detector unit subarrays shown in FIG. 3 to FIG. 14, and the M output ports respectively connected to the N photoelectric detector unit subarrays.

In a possible implementation, photoelectric detector unit subarrays included in an array in the plurality of arrays other than the at least one array are different from the N photoelectric detector unit subarrays in any one of the first aspect and the possible implementations of the first aspect.

This disclosure further provides a signal receiver. The signal receiver includes the signal processing apparatus in FIG. 3 to FIG. 14.

This disclosure further provides a signal processing device. The signal processing device includes a light source (or referred to as a transmitter, a signal transmitter, an optical signal transmitter, or the like), and the signal processing apparatus in FIG. 3 to FIG. 14.

The foregoing embodiments are intended for describing the technical solutions of this disclosure, but not for limiting this disclosure. Although this disclosure is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of embodiments of this disclosure.

What is claimed is:

1. An apparatus, comprising:
N photoelectric detector unit subarrays; and
M output ports connected to the N photoelectric detector unit subarrays, wherein
at least two of the N photoelectric detector unit subarrays are different,
a quantity of photoelectric detector units included in at least one of the N photoelectric detector unit subarrays is greater than or equal to 2,
N is an integer greater than or equal to 2,
M is an integer less than or equal to N,
a photoelectric detector unit in the N photoelectric detector unit subarrays is configured to obtain a first electrical signal by performing photoelectric conversion on an optical signal, and
the M output ports are configured to output the first electrical signal.

2. The apparatus according to claim 1, wherein at least two of the N photoelectric detector unit subarrays being different comprises at least one of:
(i) shapes of the at least two of the N photoelectric detector unit subarrays being different,
(ii) areas of the at least two of the N photoelectric detector unit subarrays being different,
(iii) quantities of photoelectric detector units comprised in the at least two of the N photoelectric detector unit subarrays being different,
(iv) areas of photosensitive surfaces of photoelectric detectors comprised in the at least two of the N photoelectric detector unit subarrays being different, or
(v) spacings between photoelectric detector units comprised in the at least two of the N photoelectric detector unit subarrays being different.

3. The apparatus according to claim 1, wherein photosensitive surfaces of an array formed by the N photoelectric detector unit subarrays are axisymmetrically distributed.

4. The apparatus according to claim 1, wherein the photoelectric detector unit comprises a switch and a photoelectric detector.

5. The apparatus according to claim 4, wherein the photoelectric detector unit further comprises an inductor and an impedance circuit.

6. The apparatus according to claim 5, wherein a difference between an impedance of the photoelectric detector and an impedance of the impedance circuit is less than a threshold.

7. The apparatus according to claim 1, wherein the N photoelectric detector unit subarrays are located on a same plane.

8. The apparatus according to claim 1, wherein
the N photoelectric detector unit subarrays comprise K photoelectric detector unit subarrays and P photoelectric detector unit subarrays,
K and P are integers greater than or equal to 1,
a sum of K and P is less than or equal to N, and
a plane formed by projections, on a first plane, of photosensitive surfaces formed by photoelectric detectors in the K photoelectric detector unit subarrays and projections, on the first plane, of photosensitive surfaces formed by photoelectric detectors in the P photoelectric detector unit subarrays is continuous.

9. The apparatus according to claim 8, wherein
photoelectric detector units, in the K photoelectric detector unit subarrays, are located on a second plane,
photoelectric detector units, in the P photoelectric detector unit subarrays, are located on a third plane, and
the second plane is not coplanar with the third plane.

10. The apparatus according to claim 9, wherein
the N photoelectric detector unit subarrays further comprise Q photoelectric detector unit subarrays,
Q is an integer greater than or equal to 1,
a sum of K, P, and Q is less than or equal to N,
the Q photoelectric detector unit subarrays are located on a plurality of planes, and
the plurality of planes are not coplanar with the second plane or the third plane.

11. The apparatus according to claim 1, further comprising:
X photoelectric detector unit subarrays, wherein
the X photoelectric detector unit subarrays are located outside a region in which the N photoelectric detector unit subarrays are located, and
photosensitive surfaces of photoelectric detectors, in the X photoelectric detector unit subarrays, are greater than photosensitive surfaces of photoelectric detectors in the N photoelectric detector unit subarrays.

12. The apparatus according to claim 1, further comprising:
a processor connected to the M output ports, wherein the processor is configured to:
receive the first electrical signal, and
determine, based on the first electrical signal, data carried by the first electrical signal.

13. The apparatus according to claim 1, further comprising:
an amplifier; and
a processor, wherein
one end of the amplifier is connected to the M output ports,
the one end of the amplifier is configured to receive the first electrical signal,
the amplifier is configured to obtain a second electrical signal by performing signal amplification on the first electrical signal,
the other end of the amplifier is connected to the processor, and the other end of the amplifier is configured to send the second electrical signal to the processor, and
the processor is configured to determine, based on the second electrical signal, data carried by the second electrical signal.

14. The apparatus according to claim 12, wherein
a region covered by the optical signal comprises a target photoelectric detector unit subarray in the N photoelectric detector unit subarrays, and
the processor is further configured to control a quantity of photoelectric detector units in the target photoelectric detector unit subarray that perform photoelectric conversion on the optical signal to be a variable value.

15. The apparatus according to claim 12, wherein the processor is further configured to:
determine, at a first moment, the region covered by the optical signal comprises a first photoelectric detector unit subarray in the N photoelectric detector unit subarrays;
sequentially control, at different moments after the first moment, photoelectric detector units in the first photoelectric detector unit subarray to perform photoelectric conversion on the optical signal, and obtain a third electrical signal, wherein the third electrical signal is used to determine a first azimuth angle of a light source that generates the optical signal;
at a second moment following the different moments after the first moment, move a lens by using a mobile apparatus, and determine the region covered by the optical signal comprises a second photoelectric detector unit subarray in the N photoelectric detector unit subarrays;
sequentially control, at different moments after the second moment, photoelectric detector units in the second photoelectric detector unit subarray to perform photoelectric conversion on the optical signal, and obtain a fourth electrical signal, wherein the fourth electrical signal is used to determine a second azimuth angle of the light source that generates the optical signal; and
determine, based on the first azimuth angle and the second azimuth angle, a distance between the light source of the optical signal and the apparatus.

16. The apparatus according to claim 12, wherein the processor is further configured to:
determine the region covered by the optical signal comprises a third photoelectric detector unit subarray in the N photoelectric detector unit subarrays;
control a fourth photoelectric detector unit subarray adjacent to the third photoelectric detector unit subarray to receive the optical signal, and obtain a fifth electrical signal; and
determine a movement path of the light source of the optical signal based on the fifth electrical signal.

17. An apparatus, comprising:
a plurality of arrays, wherein
at least one of the plurality of arrays comprises N photoelectric detector unit subarrays and M output ports connected to the N photoelectric detector unit subarrays,
at least two of the N photoelectric detector unit subarrays are different,
a quantity of photoelectric detector units comprised in at least one of the N photoelectric detector unit subarrays is greater than or equal to 2,
N is an integer greater than or equal to 2,
M is an integer less than or equal to N,
a photoelectric detector unit in the N photoelectric detector unit subarrays is configured to obtain a first electrical signal by performing photoelectric conversion on an optical signal, and
the M output ports are configured to output the first electrical signal.

18. The apparatus according to claim 17, further comprising:
a light source.
